(19) United States
(12) Patent Application Publication
(10) Pub. No.: US 2025/0196245 A1
(43) Pub. Date: Jun. 19, 2025

(54) SOLID STATE BONDING OF URANIUM TO HEAT PIPES

(71) Applicant: Space Nuclear Power Corporation, Los Alamos, CA (US)

(72) Inventors: Robert E. Hardesty, Orinda, CA (US); Marc Andrew Gibson, Medina, OH (US)

(73) Assignee: Space Nuclear Power Corporation, Los Alamos, CA (US)

(21) Appl. No.: 18/621,040

(22) Filed: Mar. 28, 2024

Related U.S. Application Data
(60) Provisional application No. 63/611,111, filed on Dec. 15, 2023.

(51) Int. Cl. G21C 15/257; B23K 20/02; G21C 3/04

(52) U.S. Cl. CPC B23K 1/14; G21C 3/16

(57) ABSTRACT

A coated metal heat pipe, method of joining the heat pipe to a block of fissionable uranium, and the fissionable block with one or more embedded heat pipes are provided for use in a nuclear space reactor. The heat pipe wall is composed of a nickel-based alloy, stainless steel, or refractory metal. A sandwich of successive copper, molybdenum and copper layers cover the heat pipe. This interface manages the shear stresses from differential thermal expansions of the core and heat pipe materials. The molybdenum also serves as a uranium diffusion barrier. After inserting each coated heat pipe into openings in the block of fissionable material, a hydraulic ram, hot isostatic press, or other means apply selected external heat and pressure in an inert environment to complete the metallurgical bond, where the copper interface layers are brought up to a near liquidus temperature.

### CROSS-REFERENCE TO RELATED APPLICATION

The present application claims priority under 35 U.S.C. 119(e) from U.S. provisional application 63/611,111, filed Dec. 15, 2023.

### TECHNICAL FIELD

The invention relates to methods of creating metal-to-metal bonds between metallic uranium fissionable core material and the walls of embedded heat pipes of a different metallic material, with emphasis on providing a strong metallurgical joint that mitigates thermal mechanical strain and expansion.

### BACKGROUND ART

Power systems based upon the use of fissionable materials like uranium require the extraction of heat from the core to generate electrical power. In land-based power plants, this is done by running a water loop through the fissionable material and extracting the heat. In space-borne applications it is more advantageous to use heat pipes embedded within the fissionable core to capture the heat. For example, NASA's Kilopower Reactor Using Stirling Technology (KRUSTY) is a developmental test reactor for eventual use in space that is fueled by a uranium-235-molybdenum alloy core to generate heat that is carried to Stirling converters with passive heat pipes filled with liquid sodium. A problem with this approach is that joining heat pipes to a fissionable core requires a metal-to-metal connection to efficiently extract the heat. As seen in FIGS. 1A, 2A and 2B, the KRUSTY test reactor used retaining rings 101 to clamp a set of eight heat pipes 103 fitted in grooves 105 against the outer perimeter 107 of the fissile core 109. FIG. 2A shows three stacked uranium core sections with heat pipes 103 loosely fitted into grooves 105 prior to insertion of the retaining ring clamps, while in FIG. 2B retaining rings 101 have been added to clamp the heat pipes 103 against the core 109.

A more efficient design would have embedded heat pipes within the fissionable U—Mo metal core to increase heat transfer and are bonded without the use of retaining rings, as represented by the twelve, eighteen, or twenty-four heat pipes 111 in FIGS. 1B-1D. But if one could imagine a heat pipe that merely is inserted into a core but not metallurgically attached then, even with a tight interference fit, a thermal barrier would still exist between that heat pipe and the core in as much as pockets of air may reside in gaps between the two. In outer space, the situation becomes more extreme in that a vacuum could exist between the heat pipe wall and the fissionable core material, creating a still more effective insulating layer that would severely inhibit heat transfer.

The efficient and high-performance needs of space-borne power systems requires a uniform high conductivity interface between the uranium core and heat pipe, which in turn demands a metallurgical joint with the strength and durability needed to maintain the connection throughout a lifetime of operation and allow for thermal energy to be readily transferred. Physically bonding the heat pipe wall and the fissionable material would allow effective heat transfer from the fissionable material to the heat pipe wall and then into the working fluid. Therefore, a key technology for any successful space reactor is the ability to create a metallurgical bond between the uranium core and the walls of embedded heat pipes. This has been a challenge not adequately resolved until this invention.

It has long been known that certain metals (e.g., copper, nickel, nickel-chromium alloys, niobium, and zirconium) can be electrodeposited or otherwise coated onto prepared metallic uranium surfaces. Examples of such coating methods for nickel or nickel alloys onto uranium are described in U.S. Pat. Nos. 2,849,348; 2,854,738; 2,894,854; and 3,888744 and U.K. Patent 829,089. Examples of such coating methods for copper onto uranium are described in U.S. Pat. Nos. 2,854,737; 2,894,855; and 4,285,782 and U.K. Patents 1,046,009 and 1,052,166. Examples of uranium surface treatments to prepare for such electrodeposition are described in U.S. Pat. Nos. 3,275,535 and 3,700,482 and U.K. Patents 788,721 and 847,904. There is also an example in U.K. Patent 1,132,808 of a method providing for successive depositions of two layers of different metals (e.g., nickel on copper) with the use of a ductile metal (e.g., indium) to fill any defects on the first coating layer.

However, such coating layers would certainly never be sufficiently thick for use as walls of any durable embedded heat pipe and would suffer from interdiffusion of uranium into the coating material during operation, adversely affecting performance. Additionally, the shear stresses from the differential thermal expansion between the uranium core and the heat pipe wall materials (which thin metal coatings need not face) would need to be addressed for any metallurgical bond to endure over the full design lifetime of the reactor. Some other method to successfully create durable bonds of uranium to embedded heat pipe walls is needed.

### SUMMARY DISCLOSURE

A method is provided for joining one or more heat pipes to a block of metallic fissionable material in which the heat pipes are embedded for use in nuclear space reactors. At least one heat pipe of specified length and circular cross section, with an outer wall of a first diameter, is coated with a sandwich of successive layers of copper, molybdenum, and copper over at least that portion of the heat pipe's length which is to be embedded within openings in the fissionable block. The heat pipe outer wall may be composed of a nickel-based alloy (such as one defined by UNS N06230), stainless steel, or a refractory metal material. The sandwich layers may be in the form of foil wrapped around the heat pipe or be deposited onto the heat pipe by plasma spraying, thermal spraying, or vapor deposition. The sandwich of successive layers coating the outer wall of each heat pipe extends the first diameter to a greater diameter. Thicknesses of the successive layers of the sandwich coating are chosen to allow thermal strain and expansion between the heat pipe outer wall material and the fissionable uranium of the block to be handled over the design life of the reactor.

At least the coated portion of the heat pipes are then received within corresponding openings in the block of fissionable material to receive the greater diameter of the coated heat pipe in a slip fit relation. The fissionable material may be a uranium-molybdenum metal alloy. After inserting of each heat pipe, a tube expander having a reach corresponding to that portion of the heat pipe inserted into the opening of the block of fissionable uranium can then expand the diameter of the heat pipe to press the heat pipe outer wall and coating layers against the holes of the block. This expansion of the heat pipe's inner diameter can be accomplished using a mechanical tube expander. Alternatively, in a step commonly referred to as hydroforming, the heat pipe's expansion can be performed using a hydraulic tube expander tool. In yet another embodiment, each heat pipe with its corresponding sandwich of successive layers can be pre-cooled prior to insertion into respective openings of a pre-heated block of the fissionable material to allow a slip fit at a temperature differential, then temperatures of the heat pipe with sandwich of successive layer and the block of fissionable material being substantially equalized at an ambient temperature to create an interference fit.

After the gap between the heat pipe and core has been removed by either by the interference fit using temperature differentials or by the forced expansion of the heat pipe outer wall into the uranium block, the assembly requires a second process step of added heat and pressure to metallurgically diffuse the materials to create a bond. This heat and pressure would best be applied to the combined assembly of heat pipe and U—Mo core by using a hot isostatic press at temperatures greater than 675° C. and pressures greater than 345 kPa for a time commensurate with the diffusion process.

For a single-step process, the slip fit of the heat pipe and successive interface layers into the U—Mo core is followed by applying temperatures greater than 675° C. and pressures greater than 345 kPa to plastically compress the U—Mo core material into the gaps and form a metallurgical bond. The applied pressure could be an external axial force (such as provided by a hydraulic ram and core confinement tooling) to upset one material within another to establish a metallurgical joint. Interference clamp rings placed around the core could also be used as a pressure applicator to produce a high force interference fit around the embedded heat pipes allowing the bond to happen when external heat is also applied. Or the applied pressure could be provided using a hot isostatic press (HIP) with an accompanying weld can to establish the pressure differentials needed at the joint. In these cases, the taking up of the gap between heat pipe and core and the formation of a metallurgical bond are accomplished simultaneously in one step.

A coated metal heat pipe is provided for fitting into an aperture of and bonding to fissionable uranium in a nuclear space reactor. The heat pipe, which may be composed of a nickel-based alloy (such as that defined by UNS N06230), stainless steel, or a refractory metal alloy, has a multi-layer coating that clads its outer wall, the multi-layer coating comprising a first layer of copper applied to an outer wall of the heat pipe along a length thereof, a second layer of molybdenum over the first layer, and a third layer of copper over the second layer. The layers have respective thicknesses selected to accommodate thermal strain and expansion between the heat pipe cladding and a block of fissionable metal directly bonded to the third layer of copper. The second layer of molybdenum also has a thickness further selected to provide a diffusion barrier for uranium.

### BRIEF DESCRIPTION OF THE DRAWINGS

FIGS. 1A-1D are top sectional views of a prior art KRUSTY test reactor (FIG. 1A) and three other core design concepts. In FIG. 1A, eight heat pipes are held against the perimeter of a core with retaining rings. In FIGS. 1B-1D, twelve, eighteen, and twenty-four heat pipes are embedded within the fissionable U—Mo metal core to increase heat transfer and are bonded without the use of retaining rings in accord with the present invention.

FIG. 2A is a perspective photographic view corresponding to the prior art KRUSTY test reactor embodiment of FIG. 1A showing three stacked uranium core sections with heat pipes loosely fitted into grooves prior to insertion of the retaining ring clamps. FIG. 2B is a perspective photographic view after the addition of the prior art retaining rings to clamp the heat pipes against the core.

FIGS. 3A and 3B are schematic perspective views of steps of a method to bond embedded heat pipes to the uranium core material. In FIG. 3A, a representative heat pipe pre-wrapped with Cu—Mo—Cu layers is inserted into a corresponding machined hole in the uranium core. In FIG. 3B, heat and pressure are applied to bond the heat pipe and core together.

FIG. 4 is a perspective view of a commercially available long-reach tube expander tool for use in expanding heat pipes after their insertion into openings in the fissionable metal block.

FIG. 5 is a schematic side sectional view of a resulting heat pipe—uranium core bond.

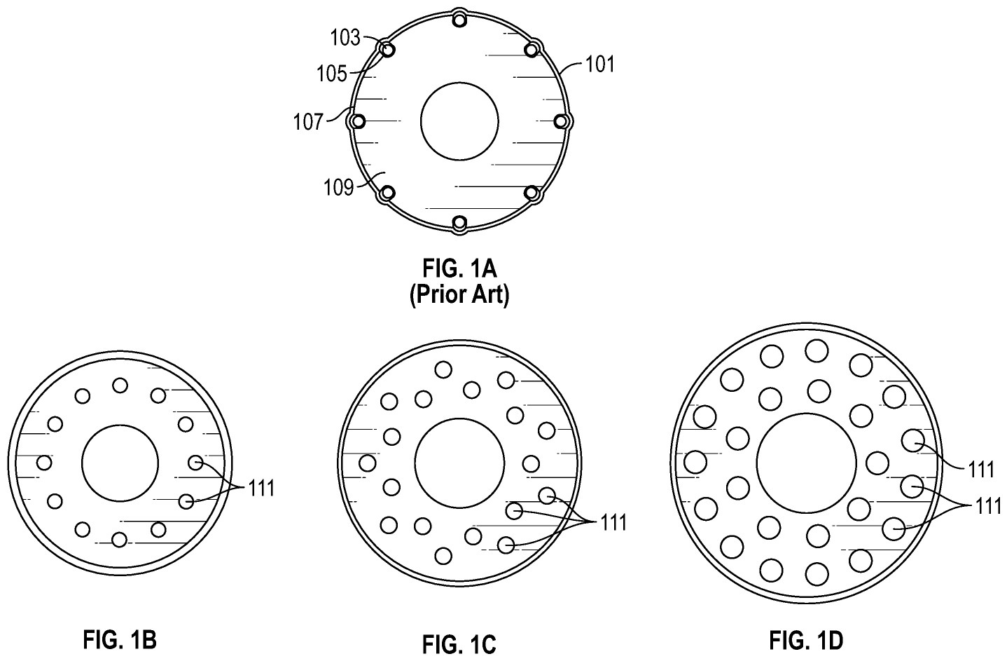

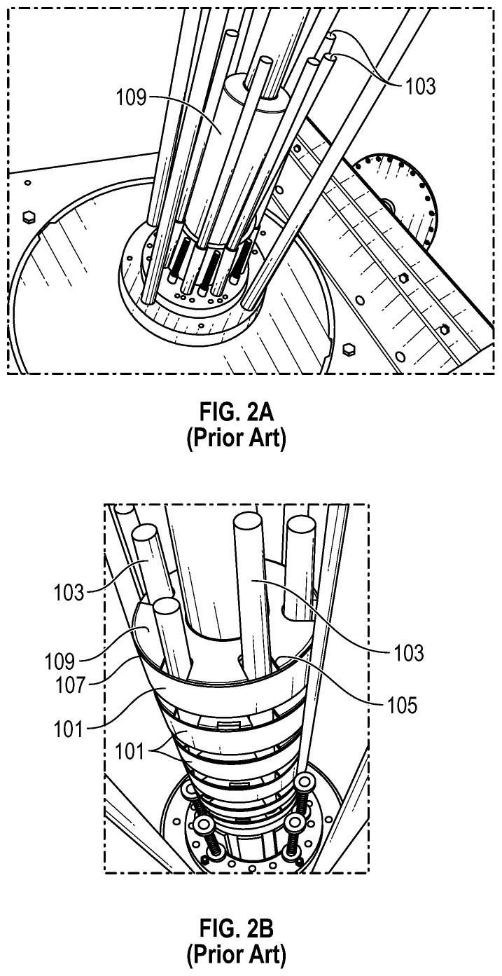

### DETAILED DESCRIPTION

Joining metals to fissionable materials like uranium has always been a challenge. In this invention a successful solid state metallurgical bond is established to uranium material. In this case, the fissionable material can be a uranium-molybdenum metal alloy, where molybdenum content ranges between 6-12 wt %. The heat pipe wall material is preferably Haynes® 230® (UNS N06230), a nickel-based superalloy with a nominal composition of 57% nickel, 22% chromium, 14% tungsten, 2% molybdenum, and minor amounts of other elements. Alternative candidates include other nickel-based materials or stainless steels (iron-chromium-nickel-molybdenum), and possibly the refractory metals Nb, Mo, Ta, W, and Re and their alloys.

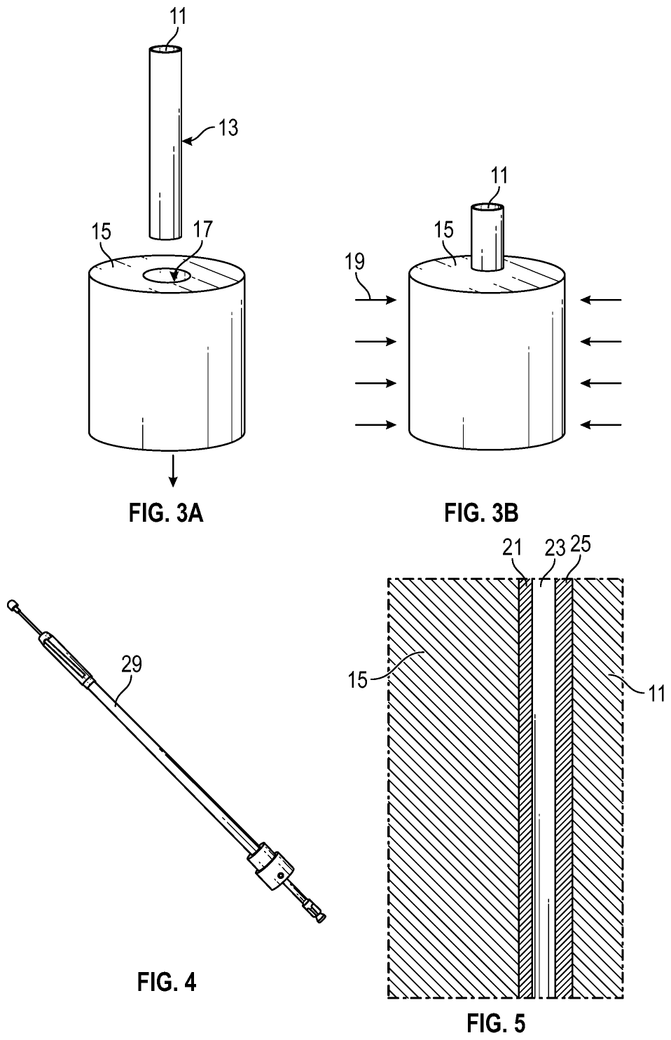

With reference to FIG. 3A, a representative heat pipe 11 is inserted into an opening 17 in the uranium core 15. Before inserting, heat pipe 11 has been covered with a sandwich of successive layers 13 of copper, molybdenum, and copper. Each of these layers might be approximately 25 μm (0.001 inch) thick, but this can vary. In a typical embodiment, the successive copper, molybdenum, and copper layers 13 are in the form of foil sheets wrapped around the outer wall of the heat pipe 11. Alternatively, the layers could be added by plasma spray, thermal spray, or vapor deposition, which are well-established commercial processes. These added layers extend the outer diameter of the heat pipe, which must be considered to achieve a slip fit for the heat pipe insertion.

After each heat pipe 11 coated with the successive layers 13 has been inserted into openings 17 in the uranium core 15, the heat pipe 11 may be expanded in diameter to create a slip fit or interference fit with that opening 17 using a tube expander. One mechanical (mandrel and expanding roller-type) tube expander tool is seen in FIG. 4. These commercial off-the-shelf products are available with a wide range of standard and custom reaches, including those with long reach over 1.5 meters. Hydraulic tube expanders that use internal hydraulic pressure to force the heat pipes to expand, known as hydroforming, are also available. First the heat pipes are assembled into the core and then expanded. Then there is a heat and pressure treatment, as further discussed below, to create the metallurgical bond.

Copper was chosen as the material that could be joined directly to the fissionable uranium material and could likewise be joined directly to the heat pipe wall material. Dissimilar coefficients of thermal expansion (CTE) exist between the fissionable uranium material and the heat pipe wall material. Molybdenum was added as a layer between the copper attaching to the uranium and the copper attaching to the heat pipe material for the express purpose of managing the coefficient of thermal expansion differences between uranium and Haynes® 230® and to provide a diffusion barrier to keep the uranium from diffusing through the copper and into the Haynes® 230®. Molybdenum also joins readily to copper, but with molybdenum's lower coefficient of thermal expansion it can manage the stresses that develop between the thermal expansion differences of uranium and Haynes. This follows a rule of mixtures approach in that so much molybdenum sandwiched between copper will result in a “designed” coefficient of thermal expansion that is a summation of the metals present. This would prevent the difference in CTEs between the fissionable material and Haynes® 230® from shearing the metallurgical joint. Copper has an added advantage in that it can also provide strain relief to diminish CTE differences and allow the captured strain to mitigate thermal mechanical loads to diminish shear stresses on the joint. This has been demonstrated through testing and is one of the key claims of this technology. The thickness of the copper layers is based on the shear stresses, while the thickness of the molybdenum is determined mainly from the diffusion characteristics through the Cu—Mo—Cu sandwich and the design lifetime of the reactor. Another key claim is the ability to join uranium to a dissimilar metal of the heat pipe, like Haynes® 230®, or another nickel-based material, or stainless steel. This invention joins all three of the metals within this solid-state joint. Uranium to copper, copper to molybdenum to copper, and then copper to Haynes® 230®. This creates an overall sandwich structure that provides for high thermal conductivity, strain relief and a solid-state attachment with an ultimate shear strength greater than 70 MPa (10,000 psi).

Other facets of the invention that contribute to the overall success are the temperature and pressures used to solid-state join the materials. With reference to FIG. 3B, once each heat pipe 11 has been inserted into a corresponding opening in the fissionable metal block 15, a combination of selected heat and applied pressure 19 is applied to create the metallurgical bond. Typical temperature and applied pressure are 675° F. or greater and around 345 kPA (50 psi) or greater for a duration of about one to two hours. Pressure can be applied in many ways. For example, a vacuum chamber with hydraulic ram and heaters can be used to hot forge the U—Mo alloy material into the gap surrounding the heat pipe. Interference clamp rings placed around the core could also be used as a pressure applicator to produce a high force interference fit around the embedded heat pipes allowing the bond to happen when external heat is also applied. Alternatively, a Hot Isostatic Press (HIP), along with an accompanying weld can, is a possible manufacturing tool and method that could apply more temperature and pressure. The pressure within the HIP vessel upsets the fissionable core material into the gap between heat pipes and core while the hot temperatures form the diffusion bond.

In this configuration, wherein we are using a copper-moly-copper sandwich between a uranium metal and Haynes® 230® (UNS N06230), we do not want to liquify the metallurgical joint to establish the connection between all metals. If we liquify one of the materials, then it would run away from the joint affecting the strength between the members and having voids in that joint due to liquidus flow. Therefore, temperature and pressures are important in creating the metallurgical joining in as much as the temperature and pressures must be brought up to a point where the copper can create a physical solid-state attachment to the corresponding metal. This can be accomplished layer by layer in individual steps or all together. When performing the joining process, the focus is on bringing the copper to a near liquidus point (at atmospheric pressure, pure copper melts and solidifies at 1085° C.) and then allowing pressure to depress the melting point at the interface between the materials and create the connection. This operation is typically done in a vacuum to allow for elevated temperature while preventing oxidation from developing on the metal surfaces. In addition, pressure can be applied to upset one material into the other. Axial force or hot isostatic pressing can be used to apply uniform pressure to effectively move one material into another.

Another way to supply the needed pressure at the joint is to begin with a room temperature interference fit between the coated heat pipe outer diameter and uranium hole inner diameter. In the assembly process, each heat pipe tube with its interface coating material is cooled down to cryogenic temperatures, while the uranium core is preheated to several hundred degrees above ambient to allow a slip fit with the large temperature differential. After the cold heat tube has been inserted into the heated uranium block, the assembly is allowed to return to ambient temperature. This creates an interference fit with significant force already between the heat pipe and uranium block. The assembly is then placed in a vacuum furnace or other oxygen-free heating device to supply the necessary temperature and time to create a diffusion bond between the heat pipe, interface material, and uranium metal alloy.

In summary, any gaps between the heat pipes and fissionable metal core after slip fit insertion can be taken up by: (a) expanding the heat pipe and core from within the heat pipe's inner diameter by using either (i) a mechanical tube expander or (ii) a hydraulic tube expander or hydroforming tool; (b) creating an interference fit by the use of temperature differentials between (cryogenically cooled) heat pipe and (≥300° C. heated) core; (c) plastically deforming the core by heating the core up and hydraulically applying pressure with a hydraulic ram to upset the U—Mo core material into the gaps, while simultaneously in a single-step process applying heat to create the metallurgical bond; or (d) plastically deforming the core and simultaneously forming the diffusion bond in a hot isostatic press with accompanying weld can, where the pressure within the HIP vessel upsets the core material into the gap instead of the hydraulic ram of (c). Options (a) and (b) only create an interference fit in a first step and therefore still require a second heating and pressure application step to produce a metallurgical diffusion bond. Options (c) and (d) are single-step processes that simultaneously eliminate the gaps and create the metallurgical bond. Option (c) or (d) can be supplemented with the addition of external interference clamp rings around the core material to aid in the closing of the gaps by also plastically deforming the core as high temperatures are applied.

This invention results, as seen in FIG. 5, in solid-state metallurgical bond between a fissionable metal block 15, interface layers of copper 21, molybdenum 23, and copper 25, and the outer walls of heat pipes 11 composed of a different metal. This solid-state bond is a compliant connection with high conductivity that can endure over the design life of a space reactor. This is an enabling technology that allows for the efficient production of power for space applications.

1. A method of joining a heat pipe to a block of fissionable uranium for a nuclear space reactor comprising,
providing at least one heat pipe of specified length and circular cross section having a first diameter with an outer wall,
coating at least a portion of the heat pipe length with a sandwich of successive layers of copper, molybdenum and copper extending the heat pipe first diameter to a greater diameter with metallurgical bonds having extents allowing thermal strain and expansion between heat pipe outer wall material and the fissionable uranium of the block,
providing for each heat pipe an opening in the block of fissionable material to receive the greater diameter of the coated heat pipe in a slip fit relation, at least the coated portion of the heat pipe length to be inserted into the opening in the block of fissionable uranium,
applying selected heat and pressure in an inert environment to the combined block of fissionable material and coated heat pipe members to bring the copper layers to a near liquidus point to complete metallurgical joinder therebetween whereby the slip fit relation between members is replaced by said joinder.

2. The method as in claim 1, wherein the block of fissionable material being composed of a uranium-molybdenum metal alloy.

3. The method as in claim 1, wherein the heat pipe wall is composed of any of a nickel-based alloy, stainless steel, or a refractory metal material.

4. The method as in claim 3, wherein the nickel-based alloy has a chemical composition defined by UNS N06230.

5. The method as in claim 1, wherein the sandwich of successive layers are in the form of foil wrapped around the heat pipe.

6. The method as in claim 1, wherein the sandwich of successive layers are deposited onto the heat pipe by any of plasma spray, thermal spray, and vapor deposition.

7. The method as in claim 1, further comprising inserting into each heat pipe a tube expander having a reach corresponding to that portion of the heat pipe inserted into the opening of the block of fissionable uranium, and then expanding the diameter of the heat pipe to press against the uranium.

8. The method as in claim 7, wherein the expanding of the diameter is accomplished mechanically by the tube expander.

9. The method as in claim 7, wherein the expanding of the diameter is accomplished hydraulically by the tube expander.

10. The method as in claim 1, wherein the selected applied heat is a temperature above 675° C.

11. The method as in claim 1, wherein the selected applied pressure is above 345 kPa.

12. The method as in claim 1, wherein the applied pressure is an external axial force to upset one material within another to establish a metallurgical joint.

13. The method as in claim 12, wherein the applied pressure is provided using a hydraulic ram.

14. The method as in claim 1, wherein the applied pressure is provided using a hot isostatic press.

15. The method as in claim 1, wherein the at least heat pipe with its corresponding sandwich of successive layers are first pre-cooled prior to insertion into respective openings of a pre-heated block of the fissionable material to allow a slip fit at a temperature differential, then temperatures of the heat pipe with sandwich of successive layer and the block of fissionable material being substantially equalized at an ambient temperature to create an interference fit prior to the applying of selected heat and pressure.

16. A coated heat pipe for fitting into an aperture of and bonding to fissionable uranium in a nuclear space reactor, comprising:
a metal heat pipe, and
a multi-layer coating having a first layer of copper applied to an outer wall of the heat pipe along a length thereof, a second layer of molybdenum over the first layer, and a third layer of copper over the second layer, the layers having respective thicknesses selected to accommodate thermal strain and expansion between the heat pipe cladding and a block of fissionable metal directly bonded to the third layer of copper.

17. The coated heat pipe as in claim 16, wherein the metal heat pipe has an outer wall cladding composed of any of a nickel-based alloy, stainless steel, or a refractory metal material.

18. The coated heat pipe as in claim 17, wherein the nickel-based alloy has a chemical composition defined by UNS N06230.

19. The coated heat pipe as in claim 16, wherein the second layer of molybdenum has a thickness further selected to provide a diffusion barrier for uranium.

20. A fissionable block having one or more embedded metal heat pipes bonded thereto, comprising:
a fissionable uranium metal block with at least one opening of a specified circular cross-section;
a corresponding metal heat pipe for each opening in the uranium metal block, each heat pipe of a specified length and circular cross section having a first diameter with an outer wall; and
a sandwich of successive first, second, and third layers of respective copper, molybdenum, and copper material covering at least a portion of the heat pipe outer wall and extending the first diameter to a greater diameter, each heat pipe with its sandwich of successive layers received within a corresponding opening in the fissionable uranium metal block in a slip fit relation, wherein the heat pipe, sandwich of layers, and uranium metal block have been pressed together and heat treated to form a uniform metallurgical bond.

21. The fissionable block with embedded heat pipes as in claim 20, wherein the fissionable uranium metal block is composed of a uranium-molybdenum alloy.

22. The fissionable uranium block with embedded heat pipes as in claim 20, wherein each heat pipe is composed of any of a nickel-based alloy, stainless steel, or a refractory metal material.

23. The fissionable uranium block with embedded heat pipes as in claim 22, wherein the nickel-based alloy has a chemical composition defined by UNS N06230.

24. The fissionable uranium block with embedded heat pipes as in claim 20, wherein the metallurgical bond has an ultimate shear strength greater than 70 MPa.

25. The fissionable uranium block with embedded heat pipes as in claim 20, wherein the copper, molybdenum, and copper layers of the sandwich have respective thicknesses selected to accommodate thermal strain and expansion between the heat pipe outer wall and the block of fissionable uranium.

26. The fissionable uranium block with embedded heat pipes as in claim 20, wherein the molybdenum layer of the sandwich has a thickness further selected to provide a diffusion barrier for uranium.
